(19) United States
(12) Patent Application Publication
(10) Pub. No.: US 2004/0075086 A1
(43) Pub. Date: Apr. 22, 2004

(54) Borosilicate glass containing zinc oxide

(76) Inventors: Silke Wolff, Hueckeswagen (DE); Ute Woelfel, Mainz (DE); Jose Zimmer, Ingelheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/451,227

(22) PCT Filed: Dec. 19, 2001
(86) PCT No.: PCT/EP01/15065

(30) Foreign Application Priority Data
Dec. 22, 2000 (DE) 100 64 808.8

(51) Int. Cl. H01B 1/00

(52) U.S. Cl. 252/500

(57) ABSTRACT

The invention relates to a borosilicate glass containing zinc oxide, which has the following composition (oxide-based in wt. %): 58-67% SiO₂, 1-5% B₂O₃, 0-5% Al₂O₃, 8-17% Na₂O, 0-12% K₂O, 3-12% MgO, 0-12% CaO, 2-8% ZnO, 1-5% TiO₂. The glass is particularly suitable for use as a hard disk substrate.

The invention relates to a borosilicate glass that contains zinc oxide as well as uses of this glass.

For the use as a substrate for data media (solid plates), glass, compared to metals such as aluminum or metal alloys, i.a., is advantageous because of its evenness and low surface roughness. Such substrate glasses must withstand chemical, thermal and mechanical stresses that are increased with use.

They thus experience high temperatures (about 400° C.), with short cooling rates, during the coating (for example by cathode spraying or sputter processes). Still other heat treatments at about 300-400° C. can also follow. The substrate glasses should therefore exhibit transformation temperatures of over 450° C. and good resistance to thermal shocks. When used as solid plates, high mechanical stresses occur, e.g., during incorporation of terminal voltages on the axis of rotation of up to 100 N/mm² as well as additional voltages by the centrifugal forces in operation at a high rpm of currently 3,500 to 20,000 rpm. Primarily 0.25 to 3.0 mm thin glasses in particular then withstand such stresses if they are surface-prestressed. Since the increase of mechanical resistance by thermal prestressing is possible only at a minimum thickness of 3 mm, glasses must be chemically prestressable for the above-mentioned use. Appropriately, they can be prestressed by ion exchange in a salt bath below transformation temperature T₉, i.e., they have enough for the exchange of suitable ions such as Li⁺ ions and/or Na⁺ ions.

In addition to the surface evenness, the chemical resistance of the substrate glass for the functionality of a solid plate is important since the write-read head slides at a distance of about 50 nm at this time on an air cushion over the rotating solid plate. This distance must be allowed to remain for a satisfactory function. It is reduced, however, if the surface of the solid-plate substrate is unstable relative to the atmospheric influence, and even before the coating a chemical attack makes the surface rough by efflorescence, or if the surface, by atmospheric influence, loses its ability to adhere to the applied series of strata and the latter is dissolved by it, which in turn results in compromises of function or failures. The substrates should thus exhibit high chemical resistance and good layer adhesion.

Another essential property of glasses that are suitable as solid-plate substrates is their thermal expansion behavior, which is not overly different from that of the coating materials (e.g., Co alloys with thermal expansion coefficient _{α20/300} of about 12×10⁻⁶/K) and primarily not overly different from that of the materials in the securing system of the disk drive (e.g., the spring-steel spindle with _{α20/300} of about 12×10⁻⁶/K) to avoid voltages. A high thermal expansion (_{α20/300}>7.0×10⁻⁶/K) is also advantageous for the laser cuttability of the glass, since in the case of high thermal expansion, the cutting time can be reduced, i.e., the throughput is increased.

Solid plates also require a high dimensional stability so as to keep the mechanism from fluttering, even at a high rpm. If the flying/sliding level of the write-read head were too low, such deviations from the horizontal rest position would cause the write-read head to lose the orientation to the information content of the spot on the solid plate (“runout”) or to collide with the solid plate (“head crash”). A requirement of materials for solid plates is thus a high specific modulus of elasticity E/p, which means a high modulus of elasticity E and/or a low density p. E/p should be more than 25×10⁵×Ncm/g. Similar requirements regarding the specific E-modulus are set owing to the problem of “sagging” in the production process, which refers to the sagging of large glass disks under their individual weight, as well as of substrates for display applications.

The properties of evenness and low surface roughness are also advantageous for display applications and for use in the telecommunication technology, e.g., as DWDM filters.

In addition to the above-mentioned material properties, which relate to the suitability as substrates for solid plates, for display applications or for telecommunication applications, the glasses, especially for the production of the above-mentioned mass products, should be producible at low production costs. To this end, the melting and hot forming behavior of the glasses must be suitable for industrial systems. The glass melts are to act on the refractory material of the melting units as little as possible, i.e., they are to be producible at low temperatures, and they are not to contain any aggressive corrosion-promoting components. Suitable glasses are to be economically producible on an industrial scale with adequate internal quality (e.g., no bubbles, knots or inclusions), e.g., on a float system or in a drawing process, e.g., preferably in a down-draw process. In particular, the production of thin (<1.5 mm) stripe-free substrates with low surface waviness via a drawing process requires a high devitrification stability of the glasses.

Numerous glasses for use as substrates for displays are already known. In addition to metals, composite materials and glass ceramics, various glasses are also known for use as substrates for solid plates. They do not meet all requirements, however, that are set for materials for solid plates or for displays to the desired high extent.

The glasses belong to the most varied glass groups, thus, e.g., borosilicate glasses, zinc silicate glasses, aminosilicate glasses and calcium silicate glasses.

Many of the known glasses contain Li to improve their prestressability.

Such glasses, as they are described in, for example, DE 42 06 268 A1, have a strong tendency toward crystallization and are therefore not producible in the required surface qualities in the drawing process.

The Li-containing glasses, and in addition the P-containing glasses of JP 2000-007372 A result in addition in their production in the corrosion of refractory material.

ZrO₂-containing glasses and glasses that contain the heavy alkaline-earth oxides SrO and/or BaO also have drawbacks with respect to their producibility.

Also, in the aluminoborosilicate glasses of JP 4-706262 B2, Li₂O, BaO, SrO, ZrO₂ and also PbO are present as facultative components. The glasses contain zinc oxide, whereby the content of ZnO can vary over a wide range. The high-ZnO-containing glasses have the drawback, however, of a low crystallization stability. The necessary presence of all three glass formers SiO₂, B₂O₃ and Al₂O₃ makes the glasses inflexible relative to special product conditions. The glasses contain little or no TiO₂ and little or no MgO, for which reason they do not have sufficiently high E-modulus values.

It is now the object of the invention to make available glasses for the production of substrates for solid plates, substrates for displays and substrates for telecommunication applications, especially for DWDM filters, i.e., glasses that exhibit the properties that are necessary for this purpose, which are in particular sufficiently stable mechanically and exhibit high chemical resistance and which are suitable for an economical production, and in particular are sufficiently crystallization-stable.

This object is achieved by the zinc oxide-containing borosilicate glasses according to claim 1.

The glasses contain 58 to 67% by weight, preferably 60 to 65% by weight, of the network former SiO₂. Higher contents would make the glasses too viscous and “long”; the good melting properties would be lost. In the case of lower concentrations, the chemical resistance and the mechanical stability would deteriorate. In addition, the tendency toward crystallization would greatly increase in the case of too low a network former content.

The glasses contain 1 to 5% by weight of the network former B₂O₃, preferably 2 to 4% by weight. The minimum content ensures a sufficient glass former proportion and good meltability. At higher concentrations than 5% by weight, the chemical resistance would deteriorate, the viscosity would increase and thus also increase the tendency toward crystallization.

In addition, with Al₂O₃, the glasses can contain a third glass former that stabilizes the system, specifically with up to 5% by weight. In the case of higher proportions, the good melting properties are lost. A content of up to 2% by weight is preferred.

Na₂O is present as a fluxing agent for reducing the melting temperatures and for making possible the chemical prestressing by ion exchange in glasses, specifically with 8 to 17% by weight.

Also, K₂O can be present in the glasses with up to 12% by weight, preferably up to 10% by weight. K₂O promotes the exchangeability of the sodium ions.

It is advantageous that the glasses do not require any Li₂O; they are thus Li₂O-free, since Li₂O would have a very negative effect on the crystallization stability.

The glasses contain 3-12% by weight, preferably 4-10% by weight, of MgO. MgO is the essential E-modulus carrier in these glasses. As additional E-modulus enhancers, the glasses can contain up to 12% by weight of CaO, preferably up to 10% by weight. At higher contents both of MgO and of CaO, the crystallization stability would deteriorate. The sum of MgO and CaO is preferably at most 20% by weight.

The glasses contain 1 to 5% by weight, preferably 2 to 3% by weight of TiO₂. Higher contents would reduce the crystallization stability; lower contents would deteriorate the chemical resistance.

To improve the heating rates in the coating processes that are necessary for the applications as solid-plate or display substrate or for telecommunication applications and thus for shortening the sputter times and increasing the processing times, the glasses can contain one or more coloring or radiation-absorbing components from the group of Fe₂O₃, CoO, CuO, V₂O₅, and Cr₂O₃, whereby the content of each individual component and the content of their sum is to be no more than 2% by weight. Higher contents were disadvantageous for the crystallization stability of the glasses.

For the hot forming properties and also for the E-modulus of the glasses, ZnO is also an important component. It increases the surface tension of the melts and improves the crystallization stability within the context of the existing portions. It is present in the glasses with at least 2% by weight and at most 8% by weight. These high contents of the important E-modulus carrier are also possible by the elimination of lithium oxide. At still higher contents, the devitrification stability would be reduced.

If the glasses in the floating process are to be processed, the proportion of ZnO is preferably limited to at most 2% by weight, since higher proportions increase the risk of disruptive ZnO coatings on the glass surface, which can be formed by evaporation and subsequent condensation in the hot forming area.

It is of great advantage that the glasses are not only Li₂O-free but rather also still free of BaO and SrO, P₂O₅ and ZrO₂. As a result, the crystallization resistance is high and, especially because of the freedom from P₂O₅, the corrosion of the refractory material is low.

The glasses according to the invention are readily chemically prestressable by ion exchange of alkali ions below the transformation temperature. Such an ion exchange can take place in a known way by introducing the glass element in melts (salt baths) of more than 90% by weight of rather low-melting potassium salts, e.g., nitrate, or else by applying pastes of rather higher-melting potassium salts, e.g., sulfate, on the surface of the glass element. Exposure times and temperatures correspond to the commonly used conditions that depend on the respective glass composition in this known ion-exchange process, i.e., times of between 0.5 and 24 hours and temperatures of between T_{g} (transformation temperature) −100 K and T_{g} −50 K, thus in these glasses temperatures of between 350 and 550° C., whereby lower temperatures make higher dwell times necessary. By the chemical prestressing, a strong and lasting prestressing can be built up, by which the already high breaking strength of the glasses is increased.

The glasses can contain the refining agents, conventional for improving glass quality, in conventional amounts. They can thus contain up to 1.5% by weight of As₂O₃, Sb₂O₃, SnO₂ and/or CeO₂. Also, the addition of 1.5% by weight each of Cl⁻, F⁻ or SO₄²⁻ is possible. The sum of As₂O₃, Sb₂O₃, CeO₂, SnO₂, Cl⁻, F⁻ and SO₄²⁻ is not to exceed 1.5% by weight, however. If the refining agents As₂O₃ and Sb₂O₃ are eliminated, the glasses can be processed not only with the various drawing processes, but also with the float process.

Embodiments

In Table 1, two examples of glasses according to the invention are indicated. The table contains their composition (in % by weight based on oxide) as well as information on essential properties of the glasses.

The raw materials of the oxides, preferably carbonates, fluorides and/or nitrates, are weighed, the refining agent is added, and the batch is well-mixed. The glass batch is melted at about 1500° C. in a continuous melting unit, then it is plained and homogenized. At a casting temperature of about 1350° C., the glass is processed.

Its high chemical resistance is documented by the information of acid-resistance class SR according to DIN 8424 and the alkali-resistance class AR according to DIN 10659. The glasses exhibit an acid-resistance class of 1 and an alkali resistance class of 1.

Its transformation temperature T_{g} of between >450° C. and <610° C. is high enough for the temperatures that occur in the sputter process and other coating processes and low enough for the chemical prestressing by ion exchange. In addition to high temperature stability, the glasses also have a high resistance to thermal shocks. With respect to the coating materials that are to be used for the substrates, the glasses exhibit good layer adhesion.

In addition, the table contains the processing temperature V_{A} [° C.], i.e., the temperature at the viscosity of 10⁴ dPas, which is <1100° C. in the glasses. The glasses thus have a viscosity behavior that is suitable for hot forming and meltability with conventional techniques. The glasses can be produced in the usual refractory units and melting tanks.

In addition, the table contains the modulus of elasticity E [GPa], determined from non-prestressed samples, density p [g/cm³] and the specific modulus of elasticity E/p [10⁵ N cm/g]. The high modulus of elasticity E of more than 70 GPa at a low density p<2,800 g/cm³ and thus the high specific modulus of elasticity E/p of more than 25×10⁵ N cm/g show the high dimensional stability of glasses. In addition, the table contains the Knoop hardness HK 0, 1/20 of the glasses, which is between 470 and 650.

In addition, the table contains the thermal expansion coefficient _{α20/300} of glasses. It is between 7×10⁻⁶/K and 10×10⁻⁶/K and thus is close enough to the expansion coefficients of the binding material, the drive shaft and the coating materials for the solid plates.

To detect the chemical prestressability, glass elements of dimensions 30 mm×30 mm×2 mm were produced and left in a bath of molten KNO₃ at 480° C. for 8 hours. By means of EDX, exchange zones with common voltage values with thicknesses of at least 10 μm could be detected.

The glasses are thus readily chemically prestressable, by which sufficiently thick compressive-stress zones are produced. As a result, their already good mechanical resistance is increased.

The glasses have good internal quality because they can be readily melted, refined and worked.

The glasses are very crystallization-stable and can be produced economically on an industrial scale.

Because of their good devitrification stability and their high surface tension, the glasses can be produced not only as thicker, but also as thin (<1.5 mm) stripe-free substrates in very good quality, especially with low (waviness<50 nm) surface waviness especially in drawing processes. The high surface quality facilitates polishing and saves cost-intensive working steps. The glasses can be polished to a surface roughness (Ra) of less than 0.5 nm.

TABLE 1
Compositions (% by weight based on oxide)
and essential properties of the glasses

| | 1 | 2 |
|---|---|---|
| SiO₂ | 63.0 | 60.2 |
| B₂O₃ | 2.7 | 3.8 |
| Al₂O₃ | — | 1.5 |
| Na₂O | 11.0 | 10.6 |
| K₂O | 10.0 | 7.2 |
| MgO | 4.0 | 4.6 |
| CaO | — | 3.1 |
| TiO₂ | 4.0 | 2.7 |
| ZnO | 5.0 | 5.8 |
| Sb₂O₃ | 0.3 | 0.5 |
| α20/300 [10⁻⁶K⁻¹] | 9.6 | 9.0 |
| Tg [° C.] | 503 | 596 |
| V_{A} [° C.] | 1009 | 1028 |
| E [GPa] | 71 | 85 |
| p[g/cm³] | 2.55 | 2.73 |
| E/p [10⁵ Ncm/g] | 27.8 | 31.1 |
| Knoop hardness [HK] | 510 | 600 |
| A [class] | 1 | 1 |
| S [class] | 1 | 1 |

The glasses according to the invention thus meet the entire requirement profile of properties to be suitable for the production of prestressed or non-prestressed solid-plate substrates, even for high rpm.

The glasses are especially well suited for use as substrates in telecommunication technologies, especially for DWDM filters, because of their thermal expansion and their chemical resistance.

They are also well suited for use as substrates in display technologies, especially as substrates for Field Emission Displays, so-called FEDs.

The glasses are not only producible with the various drawing processes, preferably with the down-draw process, but, if they are free of As₂O₃ and Sb₂O₃, they are also producible with the float process.

1. Borosilicate glass that contains zinc oxide, characterized by the following composition (in % by weight based on oxide):

| | |
|---|---|
| SiO₂ | 58-67 |
| B₂O₃ | 1-5 |
| Al₂O₃ | 0-5 |
| Na₂O | 8-17 |
| K₂O | 0-12 |
| MgO | 3-12 |
| CaO | 0-12 |
| ZnO | 2-8 |
| TiO₂ | 1-5 |

2. Borosilicate glass according to claim 1, characterized by the following composition (in % weight based on oxide):

| | |
|---|---|
| SiO₂ | 60-65 |
| B₂O₃ | 2-4 |
| Al₂O₃ | 0-2 |
| Na₂O | 8-17 |
| K₂O | 0-10 |
| MgO | 4-10 |
| CaO | 0-10 |
| ZnO | 5-6 |
| TiO₂ | 2-3 |

3. Borosilicate glass according to claim 1 or 2, characterized in that it contains in addition (in % by weight based on oxide):

| | |
|---|---|
| As₂O₃ | 0-1.5 |
| Sb₂O₃ | 0-1.5 |
| SnO₂ | 0-1.5 |
| CeO₂ | 0-1.5 |
| Cl⁻ | 0-1.5 |
| F⁻ | 0-1.5 |
| SO₄²⁻ | 0-1.5 |
| As₂O₃ + Sb₂O₃ + SnO₂ + CeO₂ + Cl⁻+ F⁻ + SO₄²⁻ | 0-1.5 |

4. Borosilicate glass according to at least one of claims 1 to 3, wherein a total of up to ≦2% by weight of one or more coloring or radiation-absorbing agents selected from the group of Fe₂O₃, CoO, CuO, V₂O₅, and Cr₂O₃ is contained.

5. Borosilicate glass according to at least one of claims 1 to 4 that exhibits a modulus of elasticity E of more than 70 GPa, a density p≦2,800 g/cm³, an acid resistance of acid resistance class SR 1, an alkali resistance of alkali resistance class AR 1 and a Knoop hardness HK 0.1/20 of between 470 and 650.

6. Use of the glass according to at least one of claims 1 to 5 for the production of a prestressed substrate glass for solid plates.

7. Use of the glass according to at least one of claims 1 to 5 as a substrate glass in display technology, especially FEDs.

8. Use of a glass according to at least one of claims 1 to 5 as a substrate glass for telecommunication applications.
